(19) United States
(12) Patent Application Publication
(10) Pub. No.: US 2016/0328078 A1
(43) Pub. Date: Nov. 10, 2016

(54) ELECTRONIC DEVICE HAVING TOUCH SCREEN

(71) Applicant: SAMSUNG ELECTRONICS CO., LTD., Suwon-si (KR)

(72) Inventors: Heonseok LEE, Suwon-si (KR); Jaewook PARK, Yongin-si (KR); Jaehyung PARK, Suwon-si (KR); Jongdae PARK, Seoul (KR); Jooyoung PARK, Guri-si (KR); Hoondo HEO, Suwon-si (KR)

(21) Appl. No.: 15/110,025

(22) PCT Filed: Jan. 7, 2015
(86) PCT No.: PCT/KR2015/000153

§ 371 Date: Jul. 6, 2016

Related U.S. Application Data
(60) Provisional application No. 61/924,539, filed on Jan. 7, 2014.

(30) Foreign Application Priority Data
Feb. 21, 2014 (KR) 10-2014-0020928

(51) Int. Cl. G06F 3/041; G06F 3/044

(52) U.S. Cl. CPC G06F 3/0416; G06F 3/044; G06F 2203/04108

(57) ABSTRACT

An electronic device according to various embodiments of the present disclosure comprises: a housing; a display module that is placed on one surface of the housing and comprises a display area and a non-display area; and at least one touch sensor located in at least a partial area of the housing, which comprises the non-display area, at least a part of the at least one touch sensor being formed to be parallel to the display module, wherein the at least one touch sensor is configured to detect input from the side surface of the housing.

### TECHNICAL FIELD

Various embodiments of the present disclosure relate to an electronic device including a touch screen.

### BACKGROUND ART

Recent electronic devices support a call function based on mobility and are used in a very wide field due to convenient usability and easy portability thereof. The electronic device provides various input types in order to provide user functions. For example, the electronic device includes a touch screen to widen a display area while reducing a weight and thickness. The touch screen may be implemented using various types. For example, the touch screen may be implemented using a resistive overlay type, a pressure type, an infrared detection type, an ultrasonic detection type, or a capacitive type. The touch screen implemented by the capacitive type, among the touch screen implementation types, is excellent in terms of durability, touch accuracy and optical characteristics. So, the demand of the touch screen in the capacitive type is increasing.

The touch screen in the capacitive type supports a proximity touch (or hovering input or indirect input) input within a predetermined distance as well as a contact touch (or direct touch) input by a contact by an object, such as a user's finger.

### DISCLOSURE OF INVENTION

### Technical Problem

An electronic device according to the prior art may receive a user input through a touch screen located on the front surface of the electronic device or through a hardware key located on the side surface of the electronic device. Further, the electronic device may provide an application or a function of the electronic device based on a user input. However, the electronic device according to the prior art has difficulty in detecting a user input made through the side surface of the electronic device through the touch screen located on the front surface of the electronic device. Further, the volume of the electronic device may be increased due to the hardware key located on the side surface of the electronic device, and the size of the touch screen may be limited to secure an internal area of the electronic device for mounting the hardware key.

Various embodiments of the present disclosure provide an electronic device including a touch screen capable of receiving an input from the side surface of the electronic device by designing a sensor (for example, sub touch sensor) in some areas associated with the touch screen.

### Solution to Problem

An electronic device according to various embodiments of the present disclosure includes: a housing; a display module located on one surface of the housing and including a display area and a non-display area; and at least one touch sensor located on at least some areas of the housing including the non-display area and having at least a part formed to be parallel to the display module, wherein the at least one touch sensor is configured to detect an input on a side surface of the housing.

### Advantageous Effects of the Invention

An electronic device including a touch screen according to various embodiments of the present disclosure may reduce the size of the electronic device and improve the design by designing a sub touch sensor in at least some areas of a housing of the electronic device and by receiving an input from the side surface of the electronic device. Further, various embodiments of the present disclosure may provide various operations by combining an input received through the sub touch sensor and an input received from a main touch screen sensor.

### BRIEF DESCRIPTION OF THE DRAWINGS

FIG. 1 is a block diagram of an electronic device according to an embodiment of the present disclosure;

FIG. 2 is plan view of a touch screen according to an embodiment of the present disclosure;

FIG. 3 is a view enlarged from area A of the touch screen of FIG. 2 according to an embodiment of the present disclosure;

FIG. 4 is a side view of the electronic device according to various embodiments of the present disclosure;

FIG. 5 illustrates a signal input of the electronic device according to an embodiment of the present disclosure;

FIG. 6 is a plan view of the touch screen according to another embodiment of the present disclosure;

FIG. 7 is a plan view of the touch screen according to various embodiments of the present disclosure;

FIG. 8 is a side view of the electronic device according to various embodiments of the present disclosure;

FIG. 9 is a side view of the electronic device according to various embodiments of the present disclosure;

FIG. 10 is a perspective view of the electronic device according to various embodiments of the present disclosure;

FIG. 11 illustrates a protective cover of the electronic device according to an embodiment of the present disclosure;

FIG. 12 illustrates the protective cover of the electronic device according to another embodiment of the present disclosure; and

FIG. 13 is a block diagram of hardware according to various embodiments of the present disclosure.

Hereinafter, a description of reference numerals is made.

100, 102, 104: electronic device 110: bus

120: processor 130: memory

131, 130: kernel 132, 330: middleware

133, 360: application programing interface (API)

134, 370: application 140: user input module

150: touch screen 160: communication module

162: network 164: server

210: touch controller 220, 440. 540: main touch sensor

231˜238, 450: sub touch sensor 240: signal wire

250: second signal wire 410, 510: glass

420, 520: adhesive layer 460, 560: display module

480, 580: housing

1300: hardware 1310: processor

1311: application processor (AP)

1313: communication processor (CP)

1314_1˜N: SIM card 1315_1˜N: slot

1380: memory 1322: internal memory

1324: external memory 1330: communication module

1331: wireless communication module 1333: Wi-Fi

1334: RF module 1335: BT

1337: GPS 1339: NC

1340: sensor module

1340A: gesture sensor 1340B: gyro sensor

1340C: atmospheric pressure sensor 1340D: magnetic sensor

1340E: acceleration sensor 1340F: grip sensor

1340G: proximity sensor 1340H: RGB sensor

1340I: biometric sensor 1340J: temperature/humidity sensor

1340K: illumination sensor 1340M: UV sensor

1350: user input module 1354: pen sensor

1356: key 1358: ultrasonic input device

1360: touch screen 1362: touch panel

1364: display module 1366: hologram

1370: interface 1378: HDMI

1374: USB 1376: projector

1378: D-SUB 1380: audio codec

1388: speaker 1384: receiver

1386: earphones 1388: microphone

1391: camera module 1395: power management module

1396: battery 1397: indicator

1398: motor

### MODE FOR THE INVENTION

Hereinafter, various embodiments of the present disclosure will be described in detail with reference to the accompanying drawings. It should be noted that the same elements will be designated by the same reference numerals although they are shown in different drawings. Further, in the following description of the present disclosure, a detailed description of known functions and configurations incorporated herein will be omitted when it may make the subject matter of the present disclosure rather unclear. In the following description, it is noted that only structural elements necessary for understanding operations according to various embodiments will be described, and the description of the other elements will be omitted in order to prevent obscuring of the subject matter of the present disclosure.

The term “include” or “may include” refers to the existence of a corresponding disclosed function, operation or component which can be used in various embodiments of the present disclosure and does not limit one or more additional functions, operations, or components. In the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Furthermore, in the present disclosure, the expression “and/or” includes any and all combinations of the associated listed words. For example, the expression “A and/or B” may include A, may include B, or may include both A and B.

The expressions such as “first”, “second”, or the like used in various embodiments of the present disclosure may modify various component elements in the various embodiments but may not limit corresponding component elements. For example, the above expressions do not limit the sequence and/or importance of the elements. The above-described expressions may be used to distinguish an element from another element. For example, a first user device and a second user device indicate different user devices although both of them are user devices. For example, without departing from the scope of the present disclosure, a first component element may be named a second component element. Similarly, the second component element also may be named the first component element.

In the case where an element is referred to as being “connected” or “accessed” to other elements, it should be understood that not only the element is directly connected or accessed to the other elements, but also another element may exist between them. Conversely, when one component element is “directly coupled” or “directly connected” to another component element, it may be construed that a third component element does not exist between the first component element and the second component element. The terms in various embodiments of the present disclosure are used to describe a specific embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

An electronic device according to various embodiments of the present disclosure may be a device with a communication function. For example, the electronic device may include at least one of a smart phone, a tablet personal computer (PC), a mobile phone, a video phone, an e-book reader, a desktop PC, a laptop PC, a netbook computer, a personal digital assistant (PDA), a portable multimedia player (PMP), an MP3 player, a mobile medical device, a camera, a wearable device (e.g., a head-mounted-device (HMD) such as electronic glasses, electronic clothes, an electronic bracelet, an electronic necklace, an electronic appcessory, an electronic tattoo, or a smart watch).

According to some embodiments, the electronic device may be a smart home appliance with a communication function. The smart home appliances may include at least one of, for example, televisions, digital video disk (DVD) players, audio players, refrigerators, air conditioners, cleaners, ovens, microwaves, washing machines, air purifiers, set-top boxes, TV boxes (e.g., HomeSync™ of Samsung, Apple TV™, or Google TV™), game consoles, electronic dictionaries, electronic keys, camcorders, or electronic frames.

According to some embodiments, the electronic device may include at least one of various medical appliances (e.g. Magnetic Resonance Angiography (MRA), Magnetic Resonance Imaging (MRI), Computed Tomography (CT) machine, and an ultrasonic machine), navigation devices, Global Positioning System (GPS) receivers, Event Data Recorders (EDRs), Flight Data Recorders (FDRs), automotive infortainment devices, electronic equipments for ships (e.g., navigation equipments for ships, gyrocompasses, or the like), avionics, security devices, head units for vehicles, industrial or home robots, Automatic Teller Machines (ATM) of banking facilities, and Point Of Sales (POSs) of shops.

According to some embodiments, the electronic device may include at least one of furniture or a part of a building/structure, an electronic board, an electronic signature receiving device, a projector, and various types of measuring devices (for example, a water meter, an electric meter, a gas meter, a radio wave meter and the like) including a camera function. An electronic device according to various embodiments of the present disclosure may be a combination of one or more of above described various devices. Also, an electronic device according to various embodiments of the present disclosure may be a flexible device. Also, an electronic device according to various embodiments of the present disclosure is not limited to the above described devices.

Hereinafter, an electronic device according to various embodiments will be described with reference to the accompanying drawings. The term “user” used in various embodiments may refer to a person who uses an electronic device or a device (for example, an artificial intelligence electronic device) that uses an electronic device.

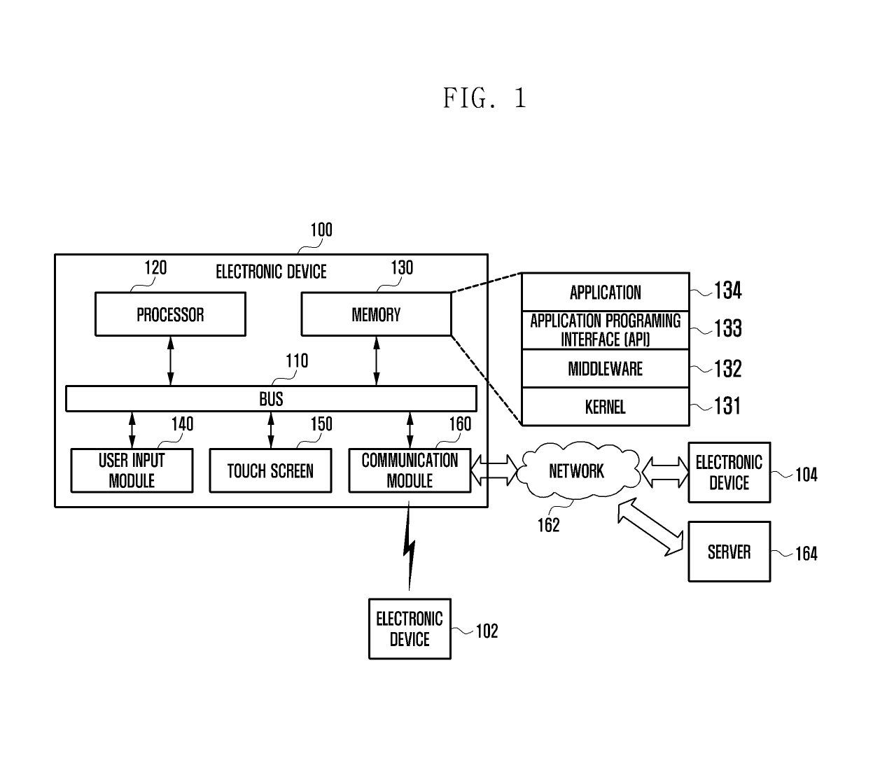

FIG. 1 is a block diagram of an electronic device according to various embodiments. Referring to FIG. 1, the electronic device 100 may include a bus 110, a processor 120, a memory 130, a user input module 140, a touch screen 150, or a communication module 160.

The bus 110 may be a circuit for connecting the aforementioned elements to each other and transmitting communication (for example, a control message) between the aforementioned elements.

The processor 120 may receive commands from the above-described other elements (for example, the memory 130, the user input module 140, the touch screen 150, the communication module 160, and the like) through the bus 110, may interpret the received commands, and may execute calculation or data processing according to the interpreted commands.

The memory 130 may store commands or data received from the processor 120 or other elements (for example, the user input module 140, the touch screen 150, the communication module 160, and the like) or generated by the processor 120 or the other elements. The memory 130 may include programming modules, for example, a kernel 131, middleware 132, an Application Programming Interface (API) 133, and applications 134. Each of the aforementioned programming modules may be formed of software, firmware, hardware, or a combination of at least two thereof.

The kernel 131 may control or manage system resources (for example, the bus 110, the processor 120, or the memory 130) used for executing an operation or a function implemented in the remaining other programming modules, for example, the middleware 132, the API 133, or the application 134. In addition, the kernel 131 may provide an interface through which the middleware 132, the API 133, or the applications 134 may control or manage the individual components of the electronic device 100 while accessing the individual components.

The middleware 132 may perform a relay function of allowing the API 133 or the application 134 to communicate with the kernel 131 to exchange data therewith. Furthermore, in regard to task requests received from the applications 134, the middleware 132 may perform a control (for example, scheduling or load balancing) for the task requests using a method of allocating a priority for using the system resources (for example, the bus 110, the processor 120, and the memory 130) of the electronic device 100 to at least one of the applications 134.

The API 133 is an interface through which the applications 134 may control functions provided by the kernel 131 and the middleware 132, and may include at least one interface or function (for example, instruction) for file control, window control, image processing, or text control.

According to the various embodiments, the applications 134 may include a Short Message Service (SMS)/Multimedia Message Service (MMS) application, an e-mail application, a calendar application, an alarm application, a health care application (for example, an application for measuring a work rate or a blood sugar), an environment information application (for example, an application for providing atmospheric pressure, humidity, or temperature information). Additionally or alternatively, the applications 134 may be an application related to information exchange between the electronic device 100 and an external electronic device (for example, the electronic device 104). The application related to the information exchange may include, for example, a notification relay application for transferring specific information to the external electronic device or a device management application for managing the external electronic device.

For example, the notification relay application may include a function of transferring, to the external electronic device (for example, the electronic device 100), notification information generated from other applications of the electronic device 104 (for example, an SMS/MMS application, an e-mail application, a health management application, an environmental information application, and the like). Additionally or alternatively, the notification relay application may, for example, receive notification information from an external electronic device (e.g., the electronic device 104) and provide the received notification information to a user. For example, the device management application may manage (for example, install, delete, or update) a function of at least a part of an external electronic device (for example, the electronic device 104) that communicates with the electronic device 100 (for example, turning on/off the external electronic device (or a few component) or adjusting brightness (or resolution) of a display), an application operated in the external electronic device, or a service provided from the external electronic device (for example, a call service or a message service).

According to various embodiments, the applications 134 may include an application specified based on the attribute (for example, type of electronic device) of an external electronic device (for example, the electronic device 104). For example, when the external electronic device is an MP3 player, the application 134 may include an application related to the reproduction of music. Similarly, when the external electronic device is a mobile medical device, the application 134 may include an application related to health care. According to various embodiments, the applications 134 may include at least one of an application designated to the electronic device 100 and an application received from the external electronic device (for example, server 106 or electronic device 104).

The user input module 140 may receive, for example, a command or data from the user and transmit the command or the data to the processor 120 or the memory 130 through the bus 110.

The communication module 160 may connect communication between another electronic device 102 and the electronic device 100. The communication module 160 may support a short-range communication protocol 162 (e.g., Wireless Fidelity (Wi-Fi), Bluetooth (BT), or Near Field Communication (NFC)), predetermined network communication (e.g., Internet, Local Area Network (LAN), Wide Area Network (WAN), telecommunication network, cellular network, or satellite network, or a Plain Old Telephone Service (POTS). Each of the electronic devices 102 and 104 may be a device that is the same as the electronic device 100 (for example, the same type device) or another device that is different from the electronic device 100 (for example, a different type device).

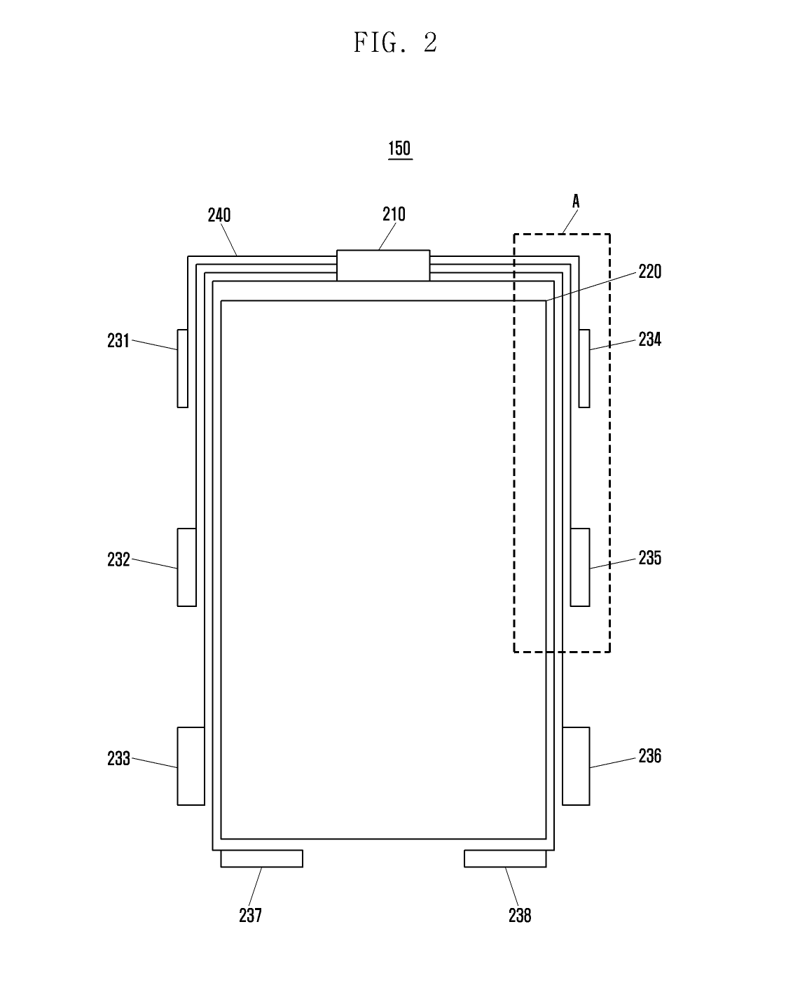

The touch screen 150 may receive various inputs from the user. For example, the touch screen 150 may receive a proximity touch from a side portion of the electronic device 100 as well as a contact touch or a proximity touch from a front direction of the touch screen. The touch screen 150 may support various screens, such as a standby screen, a menu screen, and an application execution screen required for operating the electronic device 100 based on an input from the front or the side of the touch screen 150. Additional information on the touch screen is provided through FIGS. 2 to 13.

FIG. 2 is a plan view of the touch screen according to an embodiment of the present disclosure.

Referring to FIG. 2, the touch screen 150 may include, for example, a touch controller 210 (for example, Integrated Circuit (IC)), a main touch sensor 220 (for example, touch panel), at least one sub touch sensor (for example, alternatively referred to as a sub touch sensor), 231 to 238, and a signal wire (or a trace, hereinafter referred to as a “first signal wire” for convenience of the description) 240. According to an embodiment, the touch screen 150 may additionally include another signal wire (hereinafter, referred to as a “second signal wire” for convenience of the description) for connecting a display module and the touch controller 210 as well as the display module.

The touch controller 210 may supply the current to, for example, the main touch sensor 220 or at least one sub touch sensor 231 to 238, and may receive a signal by a touch input by an object such, as a user's finger, from the main touch sensor 220 or at least one sub touch sensor 231 to 238. For example, the touch controller 210 may be connected to the main touch sensor 220 through the second signal wire. When a contact touch (or direct touch) indicating that an object (for example, a user's body part or an electronic pen) directly contacts the main touch sensor 220 or a proximity touch (or indirect touch or hovering input) indicating that the object is apart from the main touch sensor 220 is input, the touch controller 210 may receive a signal corresponding to the contact touch or the proximity touch from the main touch sensor 220 through the second signal wire.

According to an embodiment, the touch controller 210 may be connected to at least one sub touch sensor 231 to 238 through the first signal wire 240. When the proximity touch is input into at least one sub touch sensor 231 to 238, the touch controller 210 may receive a signal corresponding to the proximity touch through the first signal wire 240 connected to at least one sub touch sensor 231 to 238.

According to an embodiment, the touch controller 210 may calculate data on a coordinate where a touch is input by an object based on the signal received from the main touch sensor 220 or at least one sub touch sensor 231 to 238. To this end, the touch controller 210 may further include an Analog to Digital Converter (ADC) and a Digital Signal Processor (DSP). The ADC may convert an analog type signal to a digital type signal and output the converted signal to the DSP. The DSP may calculate a touch input coordinate (for example, x and y coordinates of a touched position) based on the digital type signal output from the ADC.

According to an embodiment, the touch controller 210 may support a capacitive type. For example, the touch controller 210 may support at least one of a self-capacitive (capacitance between a sensor pattern (or an electrode) and a ground) type and a mutual capacitive (capacitance between a driving line and a reception line) type. To this end, the touch controller 210 may further include a switching element for providing a switching function between the self-capacitive type and the mutual capacitive type. In other words, when the object contacts the touch screen 150 in a state where the proximity touch is made on the touch screen 150 according to an input by the object such as a user's finger, the touch controller 210 may control the switching element to switch the self-capacitive type to the mutual capacitive type in order to receive the contact touch input. Meanwhile, the touch controller 210 may support various types, such as a resistive overlay type, a pressure type, an infrared beam type, and a surface acoustic wave type as well as the capacitive type. Further, when functions of the touch controller 210 are performed by another module, for example, the processor 120 the touch controller 210 may be omitted. In addition, although FIG. 2 illustrates that the touch screen 150 includes only one touch controller 210, the touch screen 150 may include two or more touch controllers 210.

The main touch sensor 220 is an element included in, for example, a touch panel, and may detect a proximity touch or contact touch input from the object such as the user's finger. In other words, the main touch sensor 220 may support at least one of the self-capacitance type and the mutual capacitance type. To this end, the main touch sensor 220 may include at least one electrode for detecting a touch input from the object.

In one embodiment, when the main touch sensor 220 supports the self-capacitive type, electrodes may be patterned in the form of a plurality of strips arranged in parallel or in the form of intersecting (or crossing) x and y axes of an orthogonal coordinate system. However, such an electrode pattern is only an example, and the pattern form may include various forms such as a square, a circle, an oval, a triangle, and a polygon as well as a diamond. When the current is supplied to the main touch sensor 220 through the second signal wire, the main touch sensor 220 may detect an amount of change in the capacitance formed between the main touch sensor 220 and the object, for example, the size of the amount of the change in the capacitance and the time when the capacitance is changed. The main touch sensor 220 may transfer a signal including the detected amount of the change in the capacitance to the touch controller 210. Accordingly, the touch controller 210 may calculate a location of the coordinate of the proximity touch or the contact touch.

In another embodiment, when the main touch sensor 220 supports the mutual capacitance type, the main touch sensor 220 may include two or more electrodes. For example, each of the two or more electrodes may form a driving electrode (or referred to as a “driving line”) on an x axis and a reception electrode (or referred to as a “sensing electrode”) on a y axis of an orthogonal coordinate system. Further, when the current is supplied to the driving electrode included in the main touch sensor 220, the reception electrode may receive electric lines of force generated from the driving electrode (or form capacitance between the driving electrode and the reception electrode). When an object contacts the touch screen, the main touch sensor 220 may detect a change in electric lines of force (for example, a change in the number of electric lines of force or a change in parasitic capacitance between the object and the reception electrode) received by the reception electrode. The main touch sensor 220 may transfer a signal including the detected amount of the change in the electric lines of force, and the touch controller 210 may calculate a location of a coordinate of the proximity touch or the contact touch.

According to an embodiment, at least one sub touch sensor 231 to 238 may be implemented in the capacitive type and each of at least one sub touch sensor 231 to 238 may include electrodes. For example, at least one sub touch sensor 231 to 238 may be implemented in at least one of a self-capacitance type and a mutual capacitance type. Further, the sub touch sensors 231 to 238 may receive a signal of a proximity touch input from the side of the electronic device 100, for example, the side of the housing of the electronic device 100. The signal received by the sub touch sensors 231 to 238 according to an embodiment is not limited to a signal by a proximity touch, and sub touch sensors 231 to 238 may receive a signal by a contact touch. Further, each of at least one sub touch sensor 231 to 238 may be connected to the touch controller 210 through the first signal wire 240, and the signal received by at least one sub touch sensor 231 to 238 may be transferred to the touch controller 210.

Although FIG. 2 illustrates the sub touch sensors 231 to 233 arranged on the left side of the electronic device 100, the sub touch sensors 234 to 236 arranged on the right side, and the sub touch sensors 237 to 238 arranged on the lower side, but the sub touch sensors are not limited thereto. In other words, the arrangement and number of sub touch sensors 231 to 238 may be variously changed. For example, the number of sub touch sensors 231 to 238 may be equal to, or smaller than, 8 or larger than, or equal to, 8 according to the number or locations of touch controllers 210 and an arrangement form of the second signal wire that connects the electrode pattern included in the touch controller 210 and the main touch sensor 220. According to an embodiment, the sub touch sensors 231 to 238 may be arranged only on the left or only on the right of the electronic device 100, or arranged on the upper side of the electronic device 100, the upper surface of the housing of the electronic device 100, or the rear surface of the housing of the electronic device 100 although not illustrated in FIG. 2.

Although the sub touch sensors 231 to 238 and the main touch sensor 220 are illustrated as separated elements in FIGS. 2 to 9, the sub sensors 231 to 238 and the main touch sensor 220 may be implemented as one hardware module according to an embodiment.

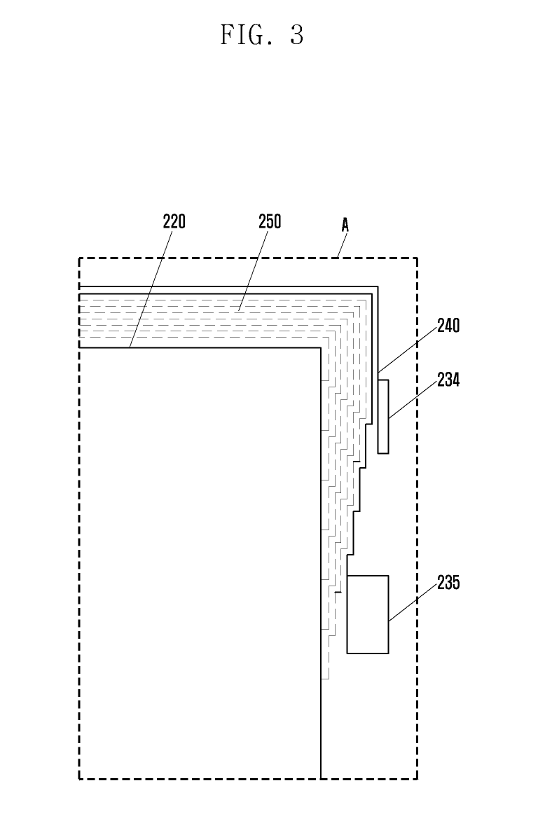

According to an embodiment of the present disclosure, the sub touch sensors 231 to 238 may be arranged on a part (a non-display area of the display module or a black mask area) in which the second signal wire for connecting the main touch sensor 220 (or electrode included in the main touch sensor 220) and the touch controller 210 is formed. It will be described in detail with reference to FIG. 3 that illustrates an area enlarged from area A of FIG. 2.

In an embodiment, the main touch sensor 220 and at least one sub touch sensor 231 to 238 may be formed of a transparent conductive medium such as Indium Tin Oxide (ITO), Indium Zinc Oxide (IZO), Al doped ZnO (AZO), Carbone NanoTube (CNT), conductive polymer (PEDOT), Ag, Cu, or the like.

FIG. 3 illustrates a view enlarged from area A of the touch screen of FIG. 2 according to an embodiment of the present disclosure.

Referring to FIGS. 2 and 3, the sub touch sensor may be connected to the touch controller 210 through a plurality of signal wires 240 (indicated by the solid line). Further, the main touch sensor 220 may be connected to the touch controller 210 through a plurality of second signal wires 250 (indicated by the broken line).

At least one sub touch sensor 231 to 238, according to an embodiment of the present disclosure, may be arranged at a location (for example, a screen non-display area or a black mask area) where the second signal wires 250 are arranged. For example, a plurality of electrodes included in the main touch sensor 220 may be connected to each of the second signal wires 250, and each of the second signal wires 250 may be arranged on the side portion (or black mask area) of the electronic device 100 (or electronic device housing) and may be connected to the touch controller 210.

According to an embodiment, the size of a space formed between the main touch senor 220 and the housing of the electronic device 100 may vary depending on the location and form of each of the second signal wires 250 as illustrated in FIG. 3. For example, the length of each of the second signal wires 520 may vary depending on the distance between a plurality of connected electrodes and the touch controller 210 and, accordingly, the size of the space formed between the second signal wires 250 and the housing of the electronic device 100 may become smaller as the second signal wires are farther from the touch controller 210.

For example, since the number of second signal wires 250 increases as the second signal wires become close to the lower side surface of the electronic device 100 in the sub touch sensors 231 to 238 as illustrated in FIG. 3, the size of a space formed between the second signal wire 250 and the housing of the electronic device 100 may become smaller. Accordingly, the size (or area) of each of the plurality of sub touch sensors 231 to 238 may be formed to be inversely proportional to the size of the space formed between the second signal wire and the peripheral area of the electronic device 100. For example, the width of the first sub touch sensor 234 may be different from the width of the second sub touch sensor 235, and the width of the first sub touch sensor 234 and the width of the second sub touch sensor 235 may be differently formed in an area corresponding to a space (or area) corresponding to the second signal wire 250 arranged on one side of the first sub touch sensor 234 or the second sub touch sensor 235.

Although FIG. 3 illustrates that the second signal wire 250 is formed on the right side of the main touch sensor 220, the present disclosure is not limited thereto. For example, when the electrode included in the main touch sensor 220 is formed in a y axis direction on the orthogonal coordinate system, a plurality of sub touch sensors 231 to 238 may be equally formed on the upper side or lower side of the main touch screen 220.

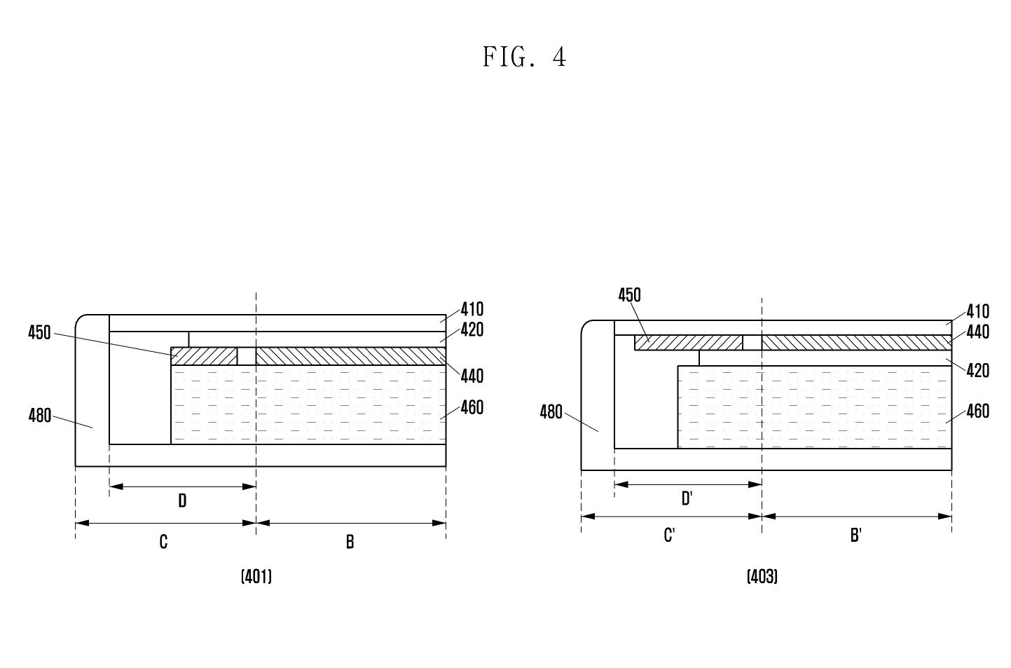

FIG. 4 is a side view of an electronic device according to various embodiments of the present disclosure.

Referring to FIG. 4, an electronic device 401 or 403 (for example, the electronic device 100) may include a glass 410, an adhesive layer 420, a main touch sensor 440, a sub touch sensor 450, a display module 460, and a housing 480. According to an embodiment, in the electronic device 401, the main touch sensor 440 and the sub touch sensor 450 (for example, touch sensor included in the touch panel) may be formed integrally with the display module 460. For example, the main touch sensor 440 and the sub touch sensor 450 may be included within the display module 450 and may be formed directly on at least one surface of the display module 460. The main touch sensor 440 may extend to at least a part of display area B of the display module 460.

The glass 410 may prevent damage of the electronic device 401 from pressure or external stimulus. The glass 410 may be formed of a transparent material, for example, Poly Carbonate (PC) of a glass material or a plastic material.

The adhesive layer 420 may provide an adhesion function. The adhesive layer 420 may be formed of a medium having excellent visibility, for example, Optically Clear Adhesive (OCA) or Super View Resin (SVR). However, the adhesive layer 420 may be omitted according to embodiments.

The display module 460 may include, for example, a display panel, a polarizing plate, or an adhesive layer for sticking together a plurality of layers. The polarizing plate may allow a light in a particular direction to pass therethough among lights output from the display panel. Further, the display module 460 may include a Liquid Crystal Display (LCD), an Active Matrix Organic Light Emitting Diode (AM-OLED), a flexible display, or a transparent display.

According to an embodiment, the display module 460 may be put on one surface of the housing 480 and may include a display area and a non-display area. For example, in the electronic device 401, the display module 460 may be accumulated on one side surface of the housing 480 and may include display area B in which screen data is displayed and a non-display area in which screen data is not displayed.

The housing 480 (or side portion) may be arranged on, for example, the lower side or the side surface of the electronic device 401 to support the glass 410, the main touch sensor 440, and the display module 460. According to an embodiment, the side surface of the housing 480 may be arranged to have a predetermined angle from the sub touch sensor 450.

For example, the sub touch sensor 450 may be arranged to parallel to the main touch sensor 440 in screen non-display area D that forms a boundary between screen display area B and a horizontal surface of the part of the side surface of the housing 480. Although not illustrated in the electronic device 401, the first signal wire 240 and the second signal wire 250 may be arranged in an area where the sub touch sensor 450 is arranged within screen non-display area D and an area between the sub touch sensor 450 and the main touch sensor 440. As described above, at least some areas of the sub touch sensor 450 may be arranged in non-display area D.

The electronic device 403 illustrates the electronic device (for example, electronic device 100) in which the sub touch sensor 450 and the main touch sensor 440 are separated from the displayed module 460. A description of elements and figures that are the same as, or similar to, those of the electronic device 401 will be omitted. In the electronic device 403, the sub touch sensor 450 and the main touch sensor 440 may be coherently accumulated on one surface (for example, internal surface which is not exposed to the outside) of the glass 410. For example, at least some areas of the sub touch sensor 450 may be formed in some areas of the glass 410.

The sub touch sensor 450 according to an embodiment may be arranged to parallel to the main touch sensor 440 in screen non-display area C′ formed in an area between screen display area B′ and the side surface of the housing 480. Like in reference numeral 401, although not illustrated, first and second signal wires (for example, first signal wire 240 and second signal wire 250) may be arranged in an area where the sub touch sensor 450 is arranged within screen non-display area C′ and an area between the sub touch sensor 450 and the main touch sensor 440. According to an embodiment, non-display area C or non-display area C′ of the electronic device 401 or the electronic device 403 may be at least some areas of the housing 480 including at least some of the non-display area of the display module 460.

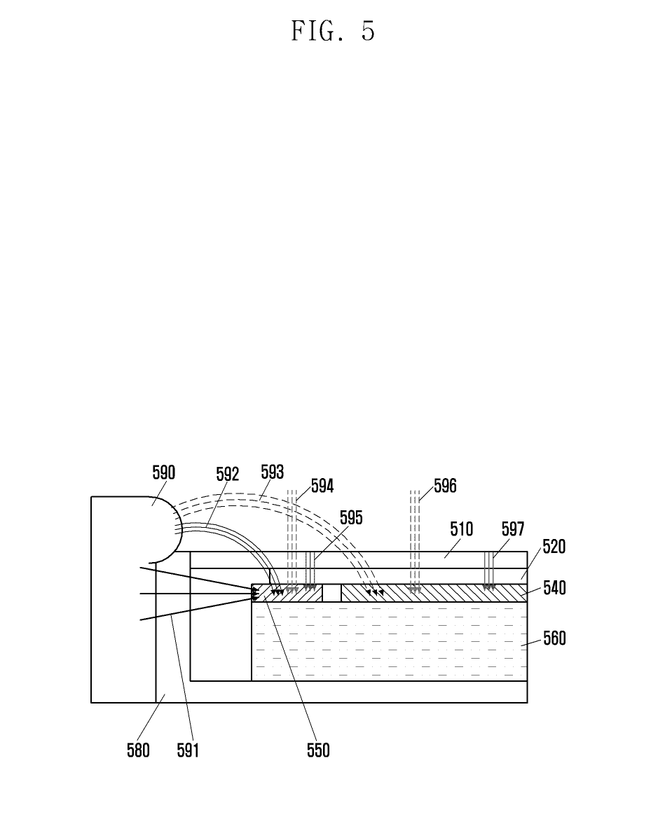

FIG. 5 illustrates a signal input of the electronic device according to an embodiment of the present disclosure. In other words, FIG. 5 illustrates a view for describing a signal generated by the touch screen 150 in a relationship with an object that contacts or approaches the side surface of the housing of the electronic device 100 according to an embodiment of the present disclosure. Further, it will be described in FIG. 5 that the electronic device 100 of FIG. 5 has the same configuration as that of the electronic device 100 of FIG. 4 indicated reference numeral 401.

Referring to FIG. 5, the touch screen 150 may receive a signal from an object, such as a finger, through the sub touch sensor 550 or the main touch sensor 540. For example, when a finger 590 contacts the side surface of a housing 580, the sub touch sensor 550 may receive a first signal (for example, an input by a proximity touch) from a part of the finger 590 spaced apart by a predetermined distance from a position perpendicular to the sub touch sensor 550 and the main touch sensor 540. Further, when the object, such as the finger 590, contacts a horizontal plane of the side surface of the housing 580 of the electronic device 100 (for example, when the finger 590 contacts an upper side surface of the housing 580), the sub touch sensor 550 may receive a second signal 592 from a part of the finger spaced apart by a predetermined distance from a position of the side surface of the housing 580 that forms a predetermined angle from the sub touch sensor 550 and the main touch sensor 540. Similarly, the main touch sensor 540 may receive a third signal 593 from a part of the finger 590 spaced apart by a predetermined distance from a position of the upper side surface of the housing 580 that forms a predetermined angle from the sub touch senor 550 and the main touch sensor 540. According to an embodiment, the sub touch sensor may transfer the first signal 591 and the second signal 592 to the touch controller 210. Further, the touch controller 210 may calculate an accurate coordinate based on the first signal 591 and the second signal 592. In addition, according to another embodiment, the main touch sensor 540 may transfer the received third signal 593 to the touch controller 210, and the touch controller 210 may calculate a more accurate coordinate based on the third signal 593 as well as the first signal 591 and the second signal 592. In other words, when the size of the input signal generated by the object, such as the finger, from the side surface of the housing 580 is small, a coordinate of the side surface of the housing 580 touched by the finger may be accurately calculated by combining the first signal 591, the second signal 592, and the third signal 593. However, this is only an example, and does not limit the technical idea of the present disclosure. For example, according to another embodiment, when the size of the first signal 591 is small, the first signal 591 may be amplified and then output. To this end, an amplifier circuit may be additionally configured in hardware or a method of giving a weighted value to the first signal in software may be adopted.

Further, the sub touch sensor 550 may receive a fourth signal (for example, proximity touch) 594 or a fifth signal (for example, contact touch) 596 input in a direction perpendicular to the sub touch sensor 550. Further, the main touch sensor 540 may also receive a sixth signal (for example, proximity touch) 596 or a seventh signal (for example, contact touch) 597 input in a direction perpendicular to the main touch sensor 540. The sub touch sensor 550 and the main touch sensor 540 may transfer the fourth signal 594 to the seventh signal 597 to the touch controller 210. According to an embodiment, the touch controller 210 may distinguish the first signal 591 to the seventh signal 597 based on an amount of a change in capacitance of a received input, for example, a difference (for example, a direction or strength of electric lines of force) of electric lines of force formed in a relationship between the object and the sub touch sensor 550 or the main touch sensor 540. For example, the second signal 592 from the part of the finger spaced apart by a predetermined distance from the position of the side surface of the housing 580 that forms the predetermined angle from the sub touch sensor 550 and the main touch sensor 540 and the fourth signal 594 input based on the direction perpendicular to the sub touch sensor 550 may have a difference in the direction of the electric lines of force formed between the sub touch sensor 550 and the finger and, accordingly, the second signal 592 and the fourth signal 594 may be distinguished.

Further, according to an embodiment, at least one of at least one sub touch sensor may further include a pressure sensor (for example, a piezoelectric pressure sensor or a piezo sensor) or may be implemented as a pressure sensor alternatively.

According to an embodiment of the present disclosure, the processor 120 may set four operation modes according to whether the sub touch sensor 550 and the main touch sensor 540 are activated/deactivated. [Table 1] below shows the four operation modes.

TABLE 1

| | | | | Fourth |
|---|---|---|---|---|
| | | | | mode |
| | First | Second | Third | (lock |
| | mode | mode | mode | mode) |
| Sub touch sensor | Activated | Activated | Deactivated | Deactivated |
| Main | Activated | Deactivated | Activated | Deactivated |
| touch sensor | | | | |

Here, the activation of the sub touch sensor 550 may be set to allow the sub touch sensor 550 to receive only the first signal 591 and the second signal 592 generated by the proximity touch on the side surface part 580 of the electronic device 100 (in other words, to exclude or filter the fourth signal and the fifth signal received by the sub touch sensor 550). In other word, the fourth signal 594 and the fifth signal 595 among the first signal 591, the second signal 592, the fourth signal 594, and the fifth signal 595 received by the sub touch sensor 550 may be set to be filtered and removed by the touch controller 210 or the processor 120. Further, the activation of the main touch sensor 540 may be set to allow only the sixth signal 596 by the proximity touch input based on a direction perpendicular to the main touch sensor 540 or the seventh signal 597 by the contact touch to be received. For example, the third signal 593 among the third signal 593, the sixth signal 596, and the seventh signal 597 received by the main touch sensor 540 may be set to be filtered and removed by the touch controller 210 or the processor 120. The four operation modes may be set by the user. Further, the four operation modes may be set according to an executed application. For example, when an MP3 application is set to operate in a second mode, the main touch sensor 540 may be deactivated or an input received by the main touch sensor 540 may be invalidated while the MP3 application is executed. In contrast, an input received by the sub touch sensor 550 from the side surface part 580 of the electronic device 100 may be validated.

According to another embodiment of the present disclosure, the processor 120 may divide the operation modes into six operation modes according to whether the sub touch sensor 550 and the main touch sensor 540 are activated/deactivated and the proximity touch/contact touch when the main touch sensor 540 is activated. [Table 2] below shows the six operation modes.

TABLE 2

| | | | | | | Sixth mode |
|---|---|---|---|---|---|---|
| | First mode | Second mode | Third mode | Fourth mode | Fifth mode | (lock mode) |
| Sub touch sensor | Activated | Activated | Activated | Deactivated | Deactivated | Deactivated |
| Main touch sensor | Activated | Activated | Deactivated | Activated | Activated | Deactivated |
| | (proximity | (contact | | (proximity | (contact | |
| | touch) | touch) | | touch) | touch) | |

In a detailed description, when the main touch sensor 540 is implemented to support both the self-capacitance type and the mutual capacitance type, the touch controller 210 may operate the touch screen 150 while switching the self-capacitance type and the mutual capacitance type. According to an embodiment, cases where the main touch sensor 540 is activated may be classified into a case where the signal by the proximity touch in the self-capacitance type is received and a case where the contact touch in the mutual capacitance type is received. For example, when a video reproduction application is set in advance to operate in the second mode by the processor 120, the input received by the sub touch sensor 550 from the side surface part 580 of the electronic device 100 and an input by the contact touch on the main touch sensor 540 are processed to be valid, but an input by the proximity touch on the main touch sensor 540 may be processed to be invalid during the reproduction of the video.

The four operation modes and the six operation modes are only examples and do not limit the technical idea of the present disclosure. For example, various operation modes may be set according to a combination of validation/invalidation of the first signal 591 to the seventh signal 597 based on the first signal 591 to the seventh signal 597. Further, in FIG. 5, an end part of the side surface of the housing 580 of the electronic device 100 (in other words, part where a vertical surface of the side surface of the housing and a horizontal surface of the side surface of the housing contact each other) may be implemented at a right angle or may be formed as a curve.

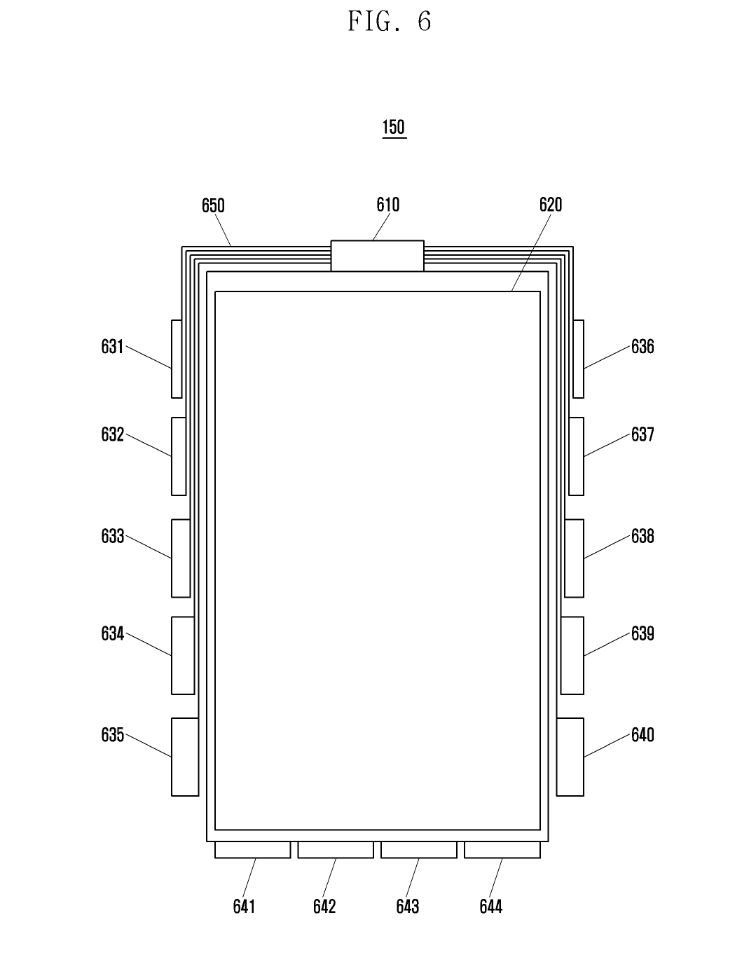

FIG. 6 is a plan view of the touch screen 150 included in the electronic device 100 according to another embodiment of the present disclosure. The touch screen 150 of FIG. 6 may include a touch controller 610, a signal wire 650, and a plurality of sub touch sensors 631 to 644.

Referring to FIGS. 2 and 6, compared to the touch screen 150 of FIG. 2, the touch screen 150 of FIG. 6 may include a larger number of sub touch sensors 631 to 644. For example, the touch screen 150 of FIG. 2 includes three sub touch sensors at each of the left/right portions, but the touch screen 150 of FIG. 6 may include five sub touch sensors at each of the left/right portions. Equally to this, the electronic device 100 may include four sub touch sensors 614 to 644 on the lower portion. However, the number of sub touch sensors 631 to 644 included in the touch screen 150 is not limited thereto and a larger number of sub touch sensors 631 to 644 may be included in the touch screen 150.

According to an embodiment of the present disclosure, when the touch screen 150 includes a plurality of sub touch sensors 631 to 644, the touch screen 150 may receive successive touch inputs such as a drag or flick. In a detailed description thereof, if the number of sub touch sensors 631 to 644 increases and an interval between the sub touch sensors 631 to 644 becomes narrower, it may be the same as a case where one electrode is arranged on a y axis (or vertical axis) on the orthogonal coordinate system of the touch screen 150. Further, if the number of sub touch sensors 631 to 644 arranged on the lower side of the touch screen 150 increases and the interval between the sub touch sensors 631 to 644 becomes narrower, it may be the same as a case where one electrode is arranged on an x axis (or horizontal axis) on the orthogonal coordinate system. Accordingly, when the user inputs successive touches, such as a drag on the left side/right side or the lower side of the housing of the electronic device 100, the sub touch sensor may detect the successive touch inputs and transfer the touch inputs to the touch controller 210, and the touch controller 210 (or processor) may calculate a coordinate on which the drag is input based on the touch inputs.

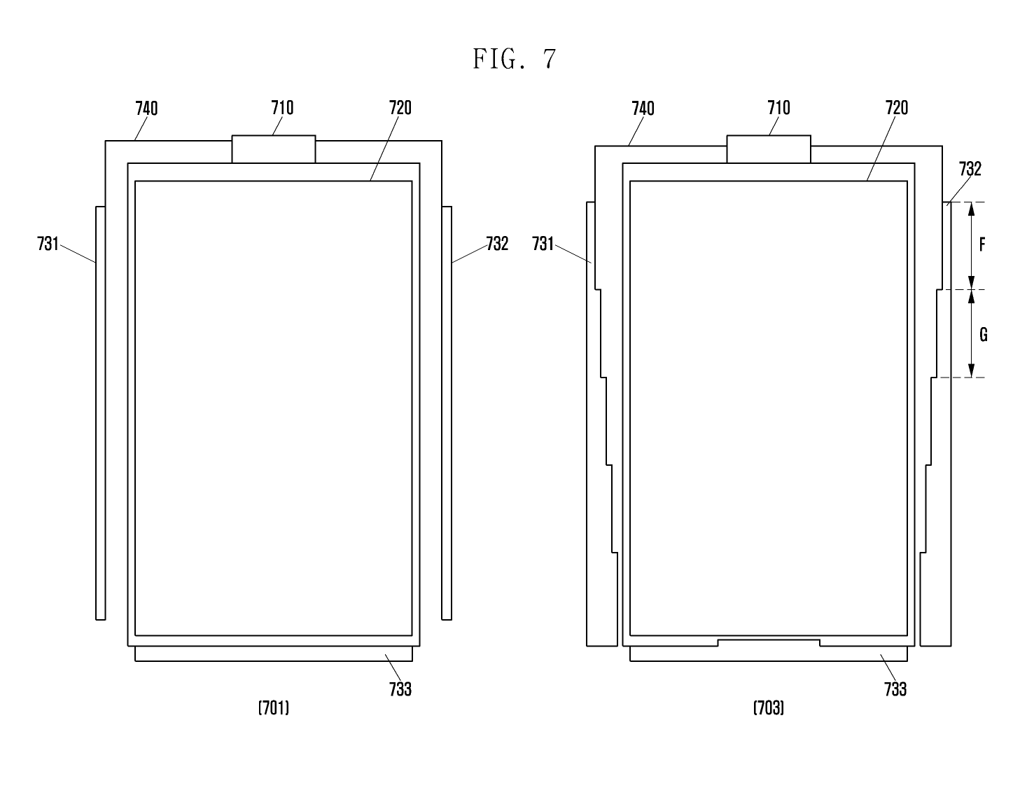

FIG. 7 is a plan view of the touch screen according to various embodiments of the present disclosure.

Referring to FIG. 7, the touch screen 150 of FIG. 7 may include sub touch sensors 731 to 733 on the left side/right side and the lower side, respectively. In a detailed description thereof, the sub touch sensors 731 to 733 arranged on the left side/right side and the lower side of the touch screen 150 may include electrodes (or electrode pattern). For example, the sub touch sensor 731 to 733 arranged on the left side/right side on the orthogonal coordinate system may include electrodes formed in a y axis direction. Further, the sub touch sensors 731 to 733 arranged on the lower side may include electrodes formed in an x axis direction. The electrodes formed in the sub touch sensors 731 to 733 may be formed in various shapes. For example, the electrodes may be formed in a square shape, a circular shape, an oval shape, a triangular shape, and a polygonal shape as well as a diamond shape.

The touch screen 150 according to an embodiment of the present disclosure may receive successive touch inputs, such as the drag or flick, through the sub touch sensors 731 to 733. In other words, when the user inputs a touch by a gesture such as a drag or flick other than a touch input on the side portion of the electronic device 100, the sub touch sensors 731 to 733 may receive the touch and transfer the touch to the touch controller. The touch controller 710 may calculate a coordinate corresponding to the successive touches based on the touch.

Further, the sub touch sensors 731 to 733 may have equal horizontal lengths (or widths) as indicated by reference numeral 701. For example, when a second signal wire 740 is arranged between the main touch sensor 720 and the sub touch sensors 731 to 733, the sub touch sensors 731 to 733 in a rectangular shape may be arranged outside the second signal wire 740 to not overlap the sub touch sensors with the second signal wire.

Alternatively, the sub touch sensors 731 to 733 may be formed to have an increasing width as the sub touch sensors 731 to 733 become farther from the touch controller 710 as indicated by reference numeral 703. For example, a part G of the sub touch sensor 732 may have a horizontal length (or width) longer than that of a part F of the sub touch sensor 732. Accordingly, in reference numeral 703, the size of the electrodes (or electrode pattern) formed in the sub touch sensors 731 to 733 may vary depending on parts in which the electrodes are formed. For example, when the electrodes formed in the sub touch sensors 731 to 733 have a diamond shape, the size of the electrode formed in the part G of the sub touch sensor may be larger than the size of the electrode formed in the part F of the sub touch sensors 731 to 733. Meanwhile, reference numerals 701 and 703 show examples in which the sub touch sensors 731 to 733 are formed, and the sub touch sensors may be formed in various shapes.

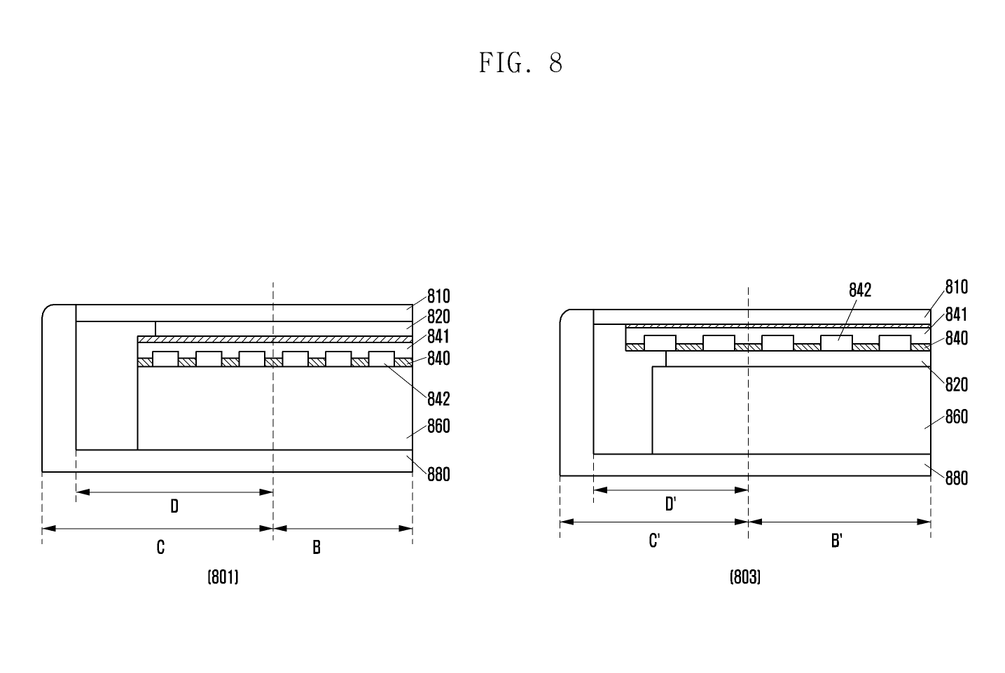

FIG. 8 is a side view of the electronic device according to various embodiments of the present disclosure.

Referring to FIG. 8, the electronic device 100 may include a glass 810, a main touch sensor 840, a display module 860, and a housing 880. In reference numeral 801, the main touch sensor 840 included in the touch panel may be formed integrally within the display module 860. Alternatively, the touch panel including the main touch sensor 840 may extend to at least a part of display area B of the display module 860.

According to an embodiment, an electrode pattern formed in the main touch sensor 840 may extend to at least a part of non-display area D in which screen data is not displayed through the display module. Reference numeral 801 shows an example of an electrode pattern of a driving line 841 and a reception line 842 in a grid shape. For example, when the main touch sensor 840 is implemented to support a mutual capacitance type, the driving line 841 and the reception line 842 included in the main touch sensor may be formed in a grid shape. However, this is an example, and the electrode pattern may be formed in various shapes. Further, the main touch sensor 840 may be implemented to support the mutual capacitance type as well as the self-capacitance type. Further, a part of the main touch sensor 840 arranged in non-display area D may detect an input for the side surface of the housing 880. For example, when a touch or drag is input on the side surface of the housing 880, the main touch sensor 840 may detect the input and transfer the input to the touch controller. Accordingly, the touch controller may determine a user gesture corresponding to the input on the side surface of the housing 880.

The glass 810 may prevent damage of the electronic device 100 from pressure or external stimulus. The glass 810 may be formed of a transparent material (for example, Poly Carbonate (PC)) of a glass material or a plastic material.

The adhesive layer 820 may provide an adhesion function. The adhesive layer 820 may be formed of a medium having excellent visibility, for example, Optically Clear Adhesive (OCA) or Super View Resin (SVR). However, the adhesive layer 820 may be omitted according to embodiments.

The display module 860 may include a Liquid Crystal Display (LCD), an Active Matrix Organic Light Emitting Diode (AM-OLED), a flexible display, or a transparent display according to an implementation type. Further, the display module 860 may be put on one surface of the housing 880 and may include a display area and a non-display area. In other words, in reference numeral 801, the display module 860 may be accumulated on one lower surface of the housing 880 and may include display area B in which screen data is displayed and a non-display area in which screen data is not displayed.

The housing 880 (or side portion) may be arranged on the lower side or the side surface of the electronic device 100 to support the glass 810, the touch panel, and the display module 860. Further, according to an embodiment, the side surface of the housing 880 may be arranged to have a predetermined angle from the main touch sensor 840.

In reference number 801, the electronic device 100 may be divided into screen display area B, which displays data on a screen, and screen non-display area C (or a set black mask area), which does not display data on the screen, based on a horizontal axis. According to an embodiment, the main touch sensor 840 may be included within the display module 860 to be formed integrally with the display module 860.

Reference numeral 803 shows the electronic device 100 in which the touch panel including the touch sensor 840 is separated from the display module 860. In reference number 803, the electronic device 100 may be divided into screen display area B′, which displays data on the screen, and screen non-display area C′ (or a set black mask area), which does not display data on the screen, based on the horizontal axis. In reference numeral 803, since a detailed description of the glass 810 and the adhesive layer 820 overlaps the description of reference numeral 801, the detailed description will be omitted. In reference numeral 803, the main touch sensor 840 may be coherently accumulated on the lower surface of the glass 810. In other words, at least some areas of the main touch sensor 840 may be formed in some areas of the glass 810.

The main touch sensor 840 according to an embodiment may expand an electrode pattern formed in the main touch sensor 840 to form a part of the main touch sensor 840 in screen non-display area D′ formed in an area between screen display area B′ and the side surface of the housing 880.

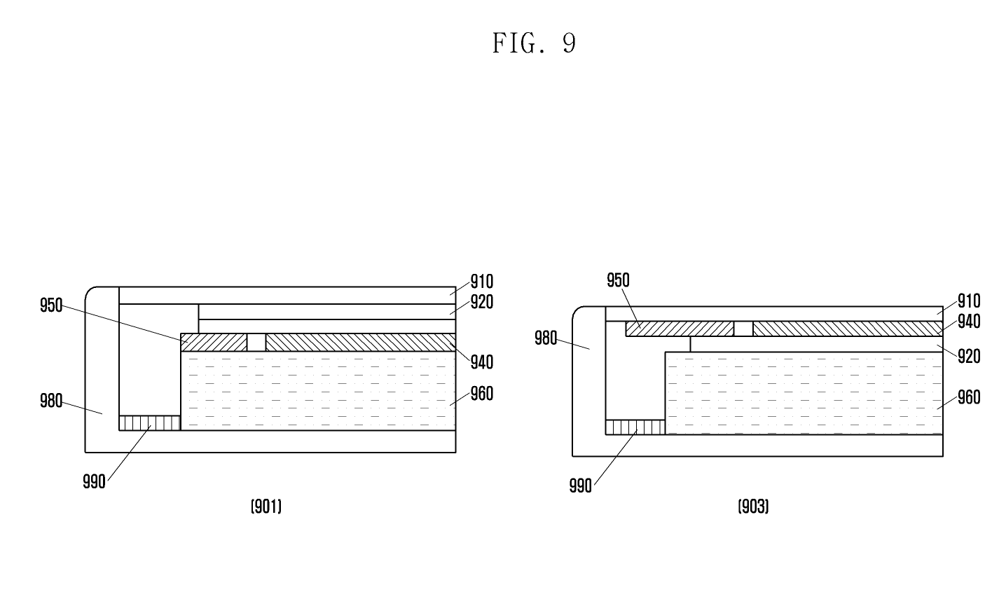

FIG. 9 is a side view of an electronic device according to various embodiments of the present disclosure. Reference numeral 901 indicates an electronic device in which a first sub touch sensor 950 and a main touch sensor 940 included in a touch panel are integrally formed in a display module 960, and reference numeral 903 indicates an electronic device in which the first sub touch sensor 950 and the main touch sensor 940 are separately formed within the display module 960.

In a comparison between the electronic device 100 of FIG. 9 and the electronic device 100 of FIG. 4, the electronic device 100 of FIG. 9 further include a second sub touch sensor as an additional element, so that a description of an overlapping element is omitted and the following description will be made based on a second touch.

Referring to FIGS. 4 and 9, the electronic device 100 may include a glass 910, a main touch sensor 940, a first sub touch sensor 950, a display module 960, a housing 980, and a second sub touch sensor 990.

The second sub touch sensor 990 may be arranged on the rear surface of the electronic device 100 and may detect an input for the rear surface (or back surface) of the housing 980 of the electronic device 100. The second sub touch sensor 990 may be implemented in a capacitive type, and each of the second touch sensor 990 may include electrodes. For example, the sub touch sensor 990 may be implemented in at least one of a self-capacitance type and a mutual capacitance type. Further, the second sub touch sensor 990 may receive a signal for a proximity touch input from the lower side of the housing 980 of the electronic device 100. However, the signal received by the second sub touch sensor 990, according to an embodiment, is not limited to the signal for the proximity touch, and the second sub touch sensor 990 may receive a signal for a contact touch. Further, the second sub touch sensor 990 may be connected to the touch controller 210 through a signal wire, and the signal received by the second sub touch sensor 990 may be transferred to the touch controller 210. Although FIG. 9 illustrates the second sub touch sensor on the lower side of the electronic device 100, the second sub touch sensor is not limited thereto. In other words, the arrangement and the number of second sub touch sensors 990 may be variously changed. Further, although FIG. 9 illustrates that the electronic device 100 includes both the first sub touch sensor 950 and the second sub touch sensor 990, the electronic device according to an embodiment may include only the second sub touch sensor without the first sub touch sensor 950.

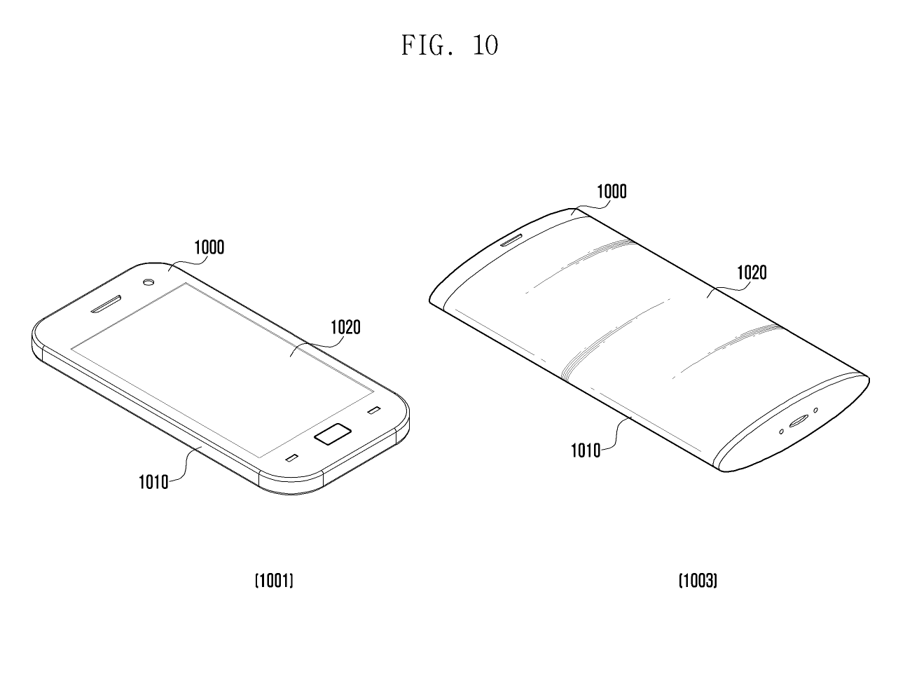

FIG. 10 is a perspective view of an electronic device according to various embodiments of the present disclosure.

Referring to FIG. 10, reference numeral 1001 indicates a perspective view of an electronic device 1000 according to an embodiment of the present disclosure. Further, reference numeral 1003 indicates a perspective view of the electronic device 1000 according to another embodiment of the present disclosure. As illustrated in reference numeral 1003, the electronic device 1000 may be implemented in an oval shape (for example, wrap-around). For example, in reference numeral 1003, the electronic device 1000 may be implemented to include a housing in an oval shape and, thus, to have a wider screen compared to the electronic device 1000 in reference numeral 1001. Further, while the electronic device 1000 has the side surface of the housing 1010 of the electronic device 1000, which is formed at a right angle as indicated by reference numeral 1001, the side surface of the housing 1010 of the electronic device 1000 may be formed in a curved shape as indicated by reference numeral 1003.

A wrap-around display may be formed by directly connecting an end of a front surface of the electronic device 200 having the display and an end of a rear surface of the electronic device 200 (for example, edges of the front surface and the rear surface contact each other or the front surface and the rear surface are configured to be one completely integrated surface). For example, at least one of the front surface and the rear surface of the electronic device may be bent, and thus, at least one side surface of the electronic device located between the front surface and the rear surface of the electronic device may be removed. For example, the electronic device may have various three-dimensional shapes, such as a ball shape having at least one surface, a cylindrical shape, a dodecahedron, or the like. Further, at least one surface included in the three-dimensional shape may include, for example, the display.

In addition, the electronic device 1000 may be implemented to detect a touch input for the side housing 1010 of the electronic device 1000. Since a detailed description thereof is the same as the description through FIGS. 1 to 9, the description will be omitted.

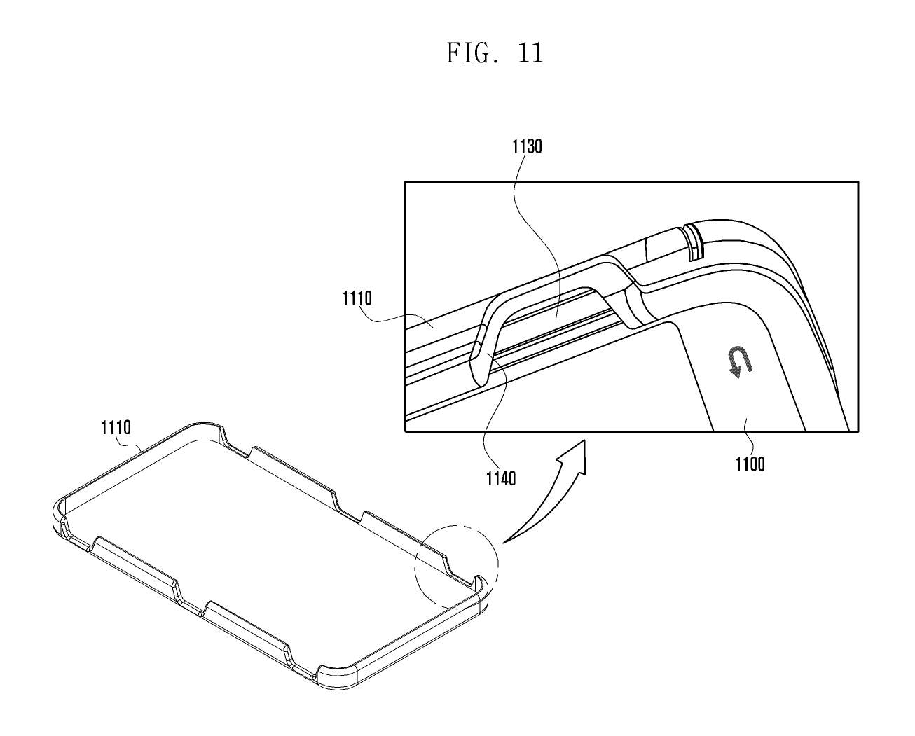

FIG. 11 illustrates a protective cover of the electronic device according to an embodiment of the present disclosure.

Referring to FIG. 11, the protective cover 1110 may be implemented to have at least one opening at the side portion of the protective cover 1110. In a detailed description, the protective cover 1110 may be implemented to have an opening at a location corresponding to a location where at least one sub touch sensor is arranged within the electronic device 1100. For example, when the electronic device includes three sub touch sensors on the left side surface or the right side surface, the protective cover 1110 may be implemented to have openings formed to expose, to the outside, positions corresponding to the positions where the sub touch sensors are located, that is, the side surface 1130 of the housing extended to be parallel from the positions of the sub touch sensors in a state where the protective cover 1110 is installed on the electronic device 1100 as illustrated in FIG. 11. Accordingly, when the object such as the user's finger contacts or approaches the side surface 1130 of the housing of the electronic device even in the state where the protective cover 1110 is installed on the electronic device 1100, a reduction in strength of a signal input into the sub touch sensor can be prevented. Further, by maintaining the thicknesses of the remaining parts of the protective cover 1110 except for the part where the openings of the protective cover 1110 are formed, an easy transformation of the protective cover 1110 can be prevented. Accordingly, it is possible to maintain a coupling force to make the protective cover 1110 not easily removed from the electronic device 1100 while the protective cover 1110 is installed on the electronic device 1100. Although FIG. 11 illustrates that lengths of the openings become shorter as they becomes close to the second surface of the protective cover 1110 when a part including the display corresponds to a first surface and an opposite surface of the first surface corresponds to a second surface in the state where the protective cover 1110 is installed on the electronic device 1100, the present disclosure is not limited thereto. In other words, the opening can have any form if the position of the housing side surface 1130 corresponding to the position where the sub touch sensor is located can be exposed to the outside in the state where the protective cover 1110 is installed on the electronic device 1100. The protective cover 1110 may be implemented to cover a part or all of the electronic device 1100.

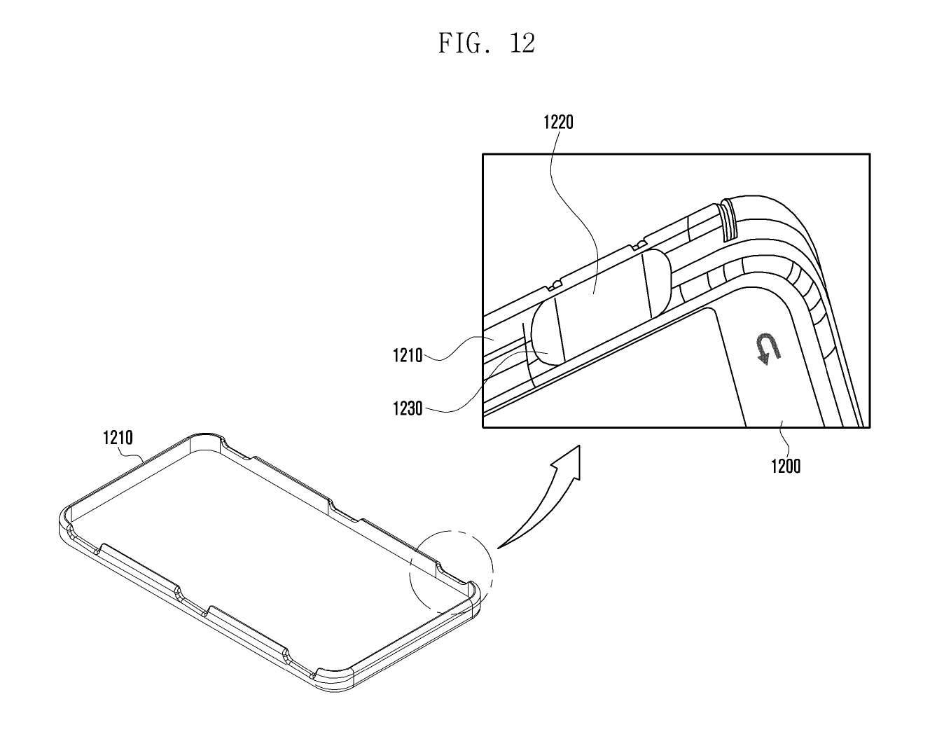

FIG. 12 illustrates a protective cover of the electronic device according to another embodiment of the present disclosure.

Referring to FIG. 12, the protective cover 1210 may be implemented such that parts of the side surfaces of the protective cover 1210 have grooves. In a detailed description thereof, the protective cover 1210 may be implemented such that a part of a position corresponding to a position where at least one sub touch sensor is arranged within the electronic device 1200 has a groove. For example, when the electronic device 1200 includes three sub touch sensors on the left side surface or the right side surface of the electronic device 1200, the protective cover 1210 may be implemented to have a form in which a position corresponding to a position where the sub touch sensor is arranged, that is, a part that contacts the side surface of the housing extended to be parallel from the position of the sub touch sensor is thinner than other parts in the state where protective cover 1210 is installed on the electronic device 1200 as illustrated in FIG. 12. Accordingly, when the object, such as the user's finger, contacts or approaches the protective cover 1210 even in the state where the protective cover 1210 is installed on the electronic device 1200, a reduction in the strength of a signal input into the sub touch sensor can be prevented. Further, by maintaining thicknesses of the other parts of the protective cover 1210 except for the groove parts, an easy transformation of the protective cover 1210 can be prevented. Accordingly, it is possible to maintain a coupling force to make the protective cover 1200 not easily removed from the electronic device 1200 while the protective cover 1210 is installed on the electronic device 1200. Although FIG. 12 illustrates that the groove part includes a cross section 1230 formed in a semicircle shape on left and right sides and a cross section 1220 formed to be parallel to the other side surface of the protective cover 1210, but the present disclosure is not limited thereto. In other words, in the state where the protective cover 1210 is installed on the electronic device 1200, the protective cover 1210 can have all forms to make a narrow interval between the position where the sub touch sensor is located and the position of the housing side surface corresponding to the position where the sub touch sensor is located. The protective cover 1210 may be implemented to cover a part or all of the electronic device 1200 like in FIG. 11.

According to an embodiment, an electronic device may include a housing, a display module located on one surface of the housing and including a display area and a non-display area, and at least one touch sensor located on at least some areas of the housing including the non-display area and having at least a part formed to be parallel to the display module, wherein the at least one touch sensor may be configured to detect an input on a side surface of the housing.

According to an embodiment, the electronic device may further include a touch panel formed in at least some areas of the display area separately from the at least one touch sensor.

According to an embodiment, at least one touch sensor may form a touch panel extended to at least some areas of the display area.

According to an embodiment, the display module may configure one surface of the electronic device, and the at least one touch sensor may be arranged to have a predetermined angle from the side surface of the housing extended to one surface of the electronic device.

According to an embodiment, at least some areas of the at least one touch sensor may be arranged in the non-display area.

According to an embodiment, at least some areas of the at least one touch sensor may be formed in some areas of the display module.

According to an embodiment, the electronic device may further include a glass configured to protect the display module, wherein at least some areas of the at least one touch sensor may be formed in some areas of the glass.

According to an embodiment, at least one of the at least one touch sensor and the touch panel may include a first touch sensor and a second touch sensor, and the first touch sensor and the second touch sensor may be arranged along at least one side surface of the display module.

According to an embodiment, the width of the first touch sensor and the width of the second touch sensor may be different from each other.

According to an embodiment, the width of the first touch sensor and the width of the second touch sensor may be formed to be different according to an area corresponding to signal wires located on one side of the first touch sensor or the second touch sensor.

According to an embodiment, the at least one touch sensor may be implemented in at least one of a self-capacitance type or a mutual-capacitance type.

According to an embodiment, the electronic device may further include a processor configured to determine a user's gesture for the electronic device based on an input detected through the at least one touch sensor.

According to an embodiment, the electronic device may further include a touch panel formed in at least some areas of the display area separately from the at least one touch sensor or having the at least one touch sensor extended to at least some areas of the display area.

According to an embodiment, the processor may be arranged along at least one side surface of the display module and connected to the at least one touch sensor or the touch panel through at least one wire.

According to an embodiment, the processor may be configured to detect a first input signal through the at least one touch sensor and to detect a second input signal through the touch panel.

According to an embodiment, the processor may determine a user's gesture based on the first input signal and the second input signal.

According to an embodiment, the processor may set an operation mode of the electronic device based on the first input signal and the second input signal.

According to an embodiment, the at least one touch sensor may be implemented in at least one of a self-capacitance type or a mutual-capacitance type.

According to an embodiment, the processor may set an operation mode of the electronic device according to at least one type between the self-capacitance type and the mutual-capacitance type in which at least one of the at least one touch sensor and the touch panel is implemented.

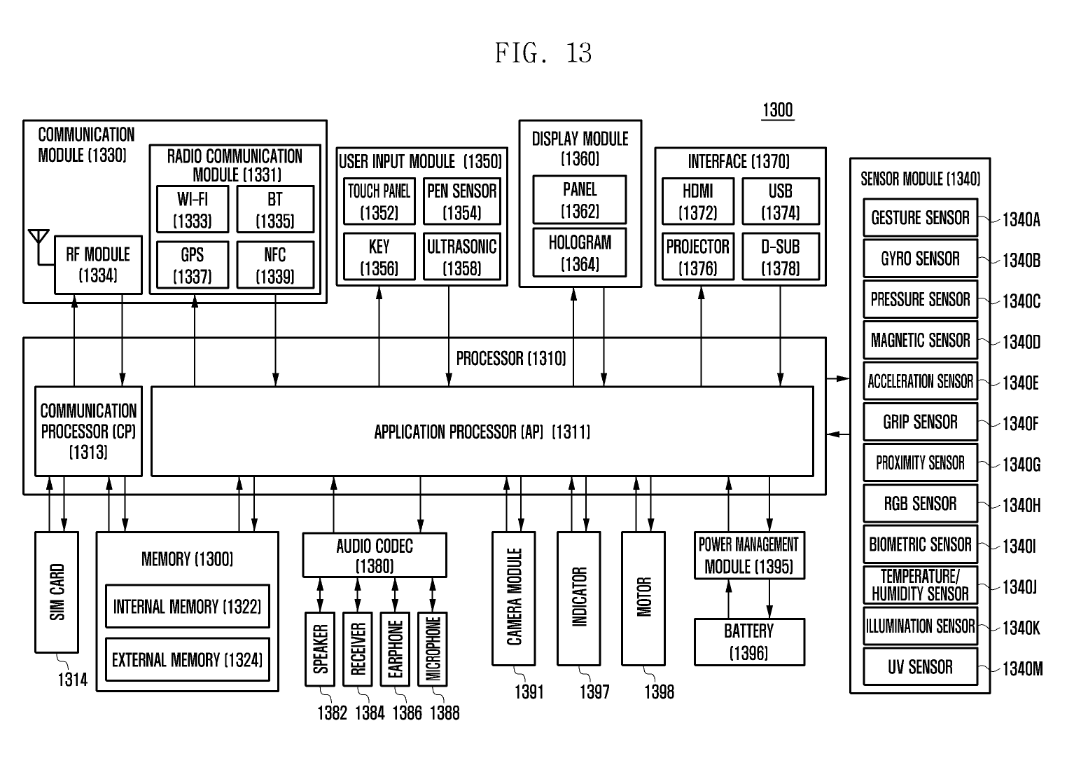

According to an embodiment, the at least one touch sensor may be configured to detect successive inputs on the side surface of the housing. FIG. 13 is a block diagram of hardware according to various embodiments of the present disclosure.

FIG. 13 is a block diagram of hardware 1300 according to various embodiments. The hardware 1300 may be, for example, the electronic device 100 illustrated in FIG. 1. Referring to FIG. 13, the hardware 1300 may include one or more processors 1310, a Subscriber Identification Module (SIM) card 1314, a memory 1320, a communication module 1330, a sensor module 1340, a user input module 1350, a display module 1360, an interface 1370, an audio codec 1380, a camera module 1391, a power management module 1395, a battery 1396, an indicator 1397, or a motor 1398.

The processor 1310 (for example, the processor 120) may include one or more Application Processors (APs) 1311 or one or more Communication Processors (CPs) 1313. The processor 1310 may be, for example, the processor 1310 illustrated in FIG. 1. Although FIG. 13 illustrates that the AP 1311 and the CP 1313 are included in the processor 1310, the AP 1311 and the CP 1313 may be included in different IC packages, respectively. In an embodiment, the AP 1311 and the CP 1313 may be included in one IC package.

The AP 1311 operates an operation system or an application program so as to control a plurality of hardware or software component elements connected to the AP 1311 and may execute various data processing and calculations including multimedia data. The AP 1311 may be implemented by, for example, a System on Chip (SoC). According to an embodiment, the processor 1310 may further include a Graphic Processing Unit (GPU) (not shown).

The CP 1313 may manage a data line of communication between the electronic device (for example, the electronic device 100) including the hardware 1300 and different electronic devices connected through the network, and may perform a function of converting a communication protocol. The CP 1313 may be implemented by, for example, an SoC. According to an embodiment, the CP 1313 may perform at least some of multimedia control functions. The CP 1313 may distinguish and authenticate a terminal within a communication network by using a subscriber identification module (for example, the SIM card 1314). Furthermore, the CP 1313 may provide a user with services, such as a voice call, a video call, a text message, packet data, or the like.

In addition, the CP 1313 may control data transmission/reception of the communication module 1330. Although FIG. 13 illustrates that the components, such as the CP 1313, the power management module 1395, and the memory 1320 are separate components of the AP 1311, the AP 1311 may include at least some of the above described components (for example, CP 1313) in an embodiment.

According to an embodiment, the AP 1311 or the CP 1313 may load a command or data received from at least one of a non-volatile memory and other component elements connected to each of the AP 211 and the CP 213 to a volatile memory, and may process the loaded command or data. Further, the AP 1311 or the CP 1313 may store data received from at least one of other components or generated by at least one of other components in a non-volatile memory.

The SIM card 1314 may be a card implementing a subscriber identification module, and may be inserted into a slot formed in a particular portion of the electronic device 100. The SIM card 1314 may include unique identification information (for example, an Integrated Circuit Card IDentifier (ICCID)) or subscriber information (for example, an International Mobile Subscriber IDentity (IMSI)).

The memory 1320 may include an internal memory 1322 or an external memory 1324. The memory 1320 may be, for example, the memory 130 illustrated in FIG. 1. The internal memory 1322 may include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like). According to an embodiment, the internal memory 1322 may be in the form of a Solid State Drive (SSD). The external memory 1324 may further include a flash drive, for example, a Compact Flash (CF), a Secure Digital (SD), a Micro Secure Digital (Micro-SD), a Mini Secure Digital (Mini-SD), an extreme Digital (xD), a memory stick, or the like.

The communication module 1330 may include a wireless communication module 1331 or an RF module 1334. The communication module 1330 may be, for example, the communication module 160 illustrated in FIG. 1. The wireless communication module 1331 may include, for example, Wi-Fi 1333, Bluetooth (BT) 1335, Global Positioning System (GPS) 1337, or Near Field Communication (NFC) 1339. For example, the wireless communication module 1331 may provide a wireless communication function by using a radio frequency. Additionally or alternatively, the wireless communication module 1331 may include a network interface (e.g., a LAN card) or a modem for connecting the hardware 1300 with a network (e.g., the Internet, a Local Area Network (LAN), a Wire Area Network (WAN), a telecommunication network, a cellular network, a satellite network, a Plain Old Telephone Service (POTS), or the like).

The RF module 1334 may transmit and receive data, for example, an RF signal or a called electronic signal. Although not illustrated, the RF module 1334 may include, for example, a transceiver, a Power Amp Module (PAM), a frequency filter, a Low Noise Amplifier (LNA), or the like. The RF module 1334 may further include a component for transmitting/receiving electronic waves over a free air space in wireless communication, for example, a conductor, a conducting wire or the like.

The sensor module 1340 may include, for example, at least one of a gesture sensor 1340A, a gyro sensor 1340B, an atmospheric pressure sensor 1340C, a magnetic sensor 1340D, an acceleration sensor 1340E, a grip sensor 1340F, a proximity sensor 1340G, a red, green, and blue (RGB) sensor 1340H, a bio-sensor 1340I, a temperature/humidity sensor 1340J, an illumination sensor 1340K, and a Ultra Violet (UV) sensor 1340M. The sensor module 1340 may measure a physical quantity or may sense an operating state of the electronic device 100, and may convert the measured or sensed information to an electrical signal. Additionally/alternatively, the sensor module 1340 may include, for example, an E-nose sensor (not illustrated), an electromyography (EMG) sensor (not illustrated), an electroencephalogram (EEG) sensor (not illustrated), an electrocardiogram (ECG) sensor (not illustrated), a fingerprint sensor, and the like. The sensor module 1340 may further include a control circuit for controlling one or more sensors included therein.

The user input module 1350 may include a (digital) pen sensor 1354, a key 1356, or an ultrasonic input device 1358. The user input module 1350 may be, for example, the user input module 140 illustrated in FIG. 1. The (digital) pen sensor 1354 may be implemented, for example, using a method that is the same as, or similar to, receiving a user's touch input, or using a separate recognition sheet. As the key 1356, for example, a keypad or touch key may be used. The ultrasonic input device 1358 is a device that can detect an acoustic wave by a microphone (for example, microphone 1388) of the terminal through a pen generating an ultrasonic signal to identify data, and can perform wireless recognition. According to an embodiment, the hardware 1300 may receive a user input from an external device (for example, network, computer, or server) connected to the hardware 1300 by using the communication module 1330.

The touch screen 1360 may include a touch panel 1362, a display module 1364, or a hologram 1366. The touch panel 1362 may receive various inputs from the user. The touch panel 1362 may recognize a touch input through at least one of, for example, a capacitive type, a resistive type, an infrared type, and an ultrasonic type. In addition, the touch panel 1362 may further include a control circuit. A capacitive type touch panel may recognize a physical contact or proximity. The touch panel 1362 may further include a tactile layer. In this case, the touch panel 1362 may provide a tactile reaction to a user.

The display module 1364 may be, for example, a Liquid Crystal Display (LCD), an Active Matrix Organic Light Emitting Diode (AM-OLED), or the like. The panel 1364 may be implemented to be, for example, flexible, transparent, or wearable. The display module 1364 and the touch panel 1362 may be implemented as one module. The hologram 1366 may show a stereoscopic image in the air by using interference of light. According to an embodiment, a control circuit for controlling the display module 1364 and the hologram 1366 may be further included.

The interface 1370 may include, for example, a High-Definition Multimedia Interface (HDMI) 1372, a Universal Serial Bus (USB) 1374, a projector 1376, or a D-subminiature (D-sub) 1378. Additionally or alternatively, the interface 1370 may include, for example, a Secure Digital (SD)/Multi-Media Card (MMC) (not illustrated), or an Infrared Data Association (IrDA) (not illustrated).

The audio codec 1380 may convert voices to electric signals, and vice versa. The audio codec 1380 may convert voice information, which is input or output through, for example, a speaker 1382, a receiver 1384, earphones 1386, the microphone 1388 or the like.

The camera module 1391 is a device that can photograph an image and a video. According to an embodiment, the camera module 1391 may include one or more image sensors (for example, a front lens or a back lens), an Image Signal Processor (ISP) (not illustrated) or a flash LED (not illustrated).

The power management module 1395 may manage power of the hardware 1300. Although not illustrated, the power management module 1395 may include, for example, a Power Management Integrated Circuit (PMIC), a charger Integrated Circuit (IC), or a battery fuel gauge.

The PMIC may be mounted, for example, in integrated circuits or SoC semiconductors. The charging methods may be classified into wired charging and wireless charging. The charger IC may charge a battery and prevent an inflow of excessive voltage or excessive current from a charger. According to one embodiment, the charger IC may include a charger IC for at least one of the wired charging method and the wireless charging method. Examples of the wireless charging may include magnetic resonance charging, magnetic induction charging, and electromagnetic charging, and an additional circuit such as a coil loop, a resonance circuit, a rectifier or the like may be added for the wireless charging.

The battery gauge may measure, for example, a remaining quantity of the battery 1396, or a voltage, a current, or a temperature during charging. The battery 1396 may generate electricity to supply power and may be, for example, a rechargeable battery.

The indicator 1397 may show particular statuses of the hardware 1300 or a part (for example, AP 1311) of the hardware, for example, a booting status, a message status, a charging status, and the like. The motor 1398 may convert an electrical signal to a mechanical vibration. An MCU 1399 may control the sensor module 1340.

Although not illustrated, the hardware 1300 may include a processing unit (for example, a GPU) for mobile TV support. The processing device for supporting the mobile TV may process media data according to standards, for example, a digital multimedia broadcasting (DMB), a digital video broadcasting (DVB), a media flow, or the like.

Each of the above-described elements of hardware according to the present disclosure may be configured with one or more elements, and the names of the corresponding elements may vary based on the type of electronic device. The hardware according to an embodiment of the present disclosure may include at least one of the above-described elements. Some of the above-described elements may be omitted from the hardware, or the hardware may further include additional elements. In addition, some elements of the hardware according to the present disclosure may be combined with each other to form a single entity so as to equivalently execute functions that the corresponding elements have executed before the combination thereof.

The term “module” used in the present disclosure may refer to, for example, a unit including one or more combinations of hardware, software, and firmware. The “module” may be interchangeable with a term, such as a unit, a logic, a logical block, a component, or a circuit. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

As described above, a touch screen and an electronic device including the touch screen according to various embodiments of the present disclosure may design a separate sub touch sensor in a black mask area of the electronic device, and may receive an input from the side surface of the electronic device, thereby reducing the size of the electronic device and improving the design. Further, various embodiments of the present disclosure may provide various operations by combining an input received through the sub touch sensor and an input received from a main touch screen sensor.

Meanwhile, the exemplary embodiments disclosed in the specification and drawings are merely presented to easily describe technical contents of the present disclosure and help the understanding of the present disclosure and are not intended to limit the scope of the present disclosure. Accordingly, the scope of the present disclosure should be construed that all modifications or modified forms derived based on the technical idea of the present disclosure are included in the scope of the present disclosure.

1. An electronic device comprising:
a housing;
a display module located on one surface of the housing and including a display area and a non-display area; and
at least one touch sensor located on at least some areas of the housing including the non-display area, and having at least a part formed to be parallel to the display module,
wherein the at least one touch sensor is configured to detect an input on a side surface of the housing.

2. The electronic device of claim 1, further comprising a touch panel formed in at least some areas of the display area separately from the at least one touch sensor.

3. The electronic device of claim 1, wherein the at least one touch sensor forms a touch panel extended to at least some areas of the display area.

4. The electronic device of claim 1, wherein the display module configures one surface of the electronic device and is arranged to have a predetermined angle from the side surface of the housing extended from one surface of the electronic device.

5. The electronic device of claim 1, wherein at least some areas of the at least one touch sensor is arranged in the non-display area.

6. The electronic device of claim 1, wherein at least some areas of the at least one touch sensor is formed in some areas of the display module.

7. The electronic device of claim 1, further comprising a glass configured to protect the display module, wherein at least some areas of the at least one touch sensor is formed in some areas of the glass.

8. The electronic device of claim 1, wherein the at least one touch sensor includes a first touch sensor and a second touch sensor, and the first touch sensor and the second touch sensor are arranged along at least one side surface of the display module.

9. The electronic device of claim 8, wherein the width of the first touch sensor and the width of the second touch sensor are different from each other.

10. The electronic device of claim 8, wherein the width of the first touch sensor and the width of the second touch sensor are formed to be different according to an area corresponding to signal wires located on one side of the first touch sensor or the second touch sensor.

11. The electronic device of claim 1, wherein the at least one touch sensor is implemented in at least one of a self-capacitance type or a mutual-capacitance type.

12. The electronic device of claim 1, further comprising a processor configured to determine a user's gesture for the electronic device based on an input detected through the at least one touch sensor.

13. The electronic device of claim 1, further comprising a touch panel formed in at least some areas of the display area separately from the at least one touch sensor or having the at least one touch sensor extended to at least some areas of the display area.

14. The electronic device of claim 12, wherein the processor is arranged along at least one side surface of the display module and connected to the at least one touch sensor or the touch panel through at least one wire.

15. The electronic device of claim 12, wherein the processor is configured to detect a first input signal through the at least one touch sensor and to detect a second input signal through the touch panel.

16. The electronic device of claim 15, wherein the processor determines a user's gesture based on the first input signal and the second input signal.

17. The electronic device of claim 16, wherein the processor sets an operation mode of the electronic device based on the first input signal and the second input signal.

18. The electronic device of claim 12, wherein at least one of the at least one touch sensor and the touch panel is implemented in at least one of a self-capacitance type and a mutual-capacitance type.

19. The electronic device of claim 18, wherein the processor sets an operation mode of the electronic device according to at least one type between the self-capacitance type and the mutual-capacitance type in which at least one of the at least one touch sensor and the touch panel is implemented.

20. The electronic device of claim 1, wherein the at least one touch sensor is configured to detect successive inputs on the side surface of the housing.
